(19) United States
(12) Patent Application Publication
(10) Pub. No.: US 2014/0164441 A1
(43) Pub. Date: Jun. 12, 2014

(54) DYNAMIC DATA INTEROPERABILITY GATEWAY

(71) Applicant: Turning Technologies, LLC, Youngstown, OH (US)

(72) Inventors: Tina Rooks, Orlando, FL (US); Fares Bouchedid, Poland, OH (US); Dave Chizar, Naperville, IL (US); John Sofko, Sarver, PA (US); Alan Johnson, Poland, OH (US)

(73) Assignee: Turning Technologies, LLC, Youngstown, OH (US)

(21) Appl. No.: 14/104,478

(22) Filed: Dec. 12, 2013

Related U.S. Application Data
(60) Provisional application No. 61/736,244, filed on Dec. 12, 2012.

(51) Int. Cl. G06F 17/30

(52) U.S. Cl. CPC G06F 17/30569
USPC 707/803

(57) ABSTRACT

A dynamic data gateway comprises at least one processor, at least one computer-readable tangible storage device, and program instructions stored on the at least one storage device for execution by the at least one processor. The program instructions comprise first program instructions configured to receive data comprising a first format. The program instructions further comprise second program instructions configured to convert the received data to a second format. The program instructions further comprise third program instructions configured to store the converted data. The program instructions further comprise fourth program instructions configured to receive a request to provide the stored data in a requested format. The program instructions further comprise fifth program instructions configured to convert the stored data to the requested format.

### CROSS-REFERENCE TO RELATED APPLICATIONS

This application claims priority from U.S. Provisional Patent Application No. 61/736,244, filed on Dec. 12, 2012, which is incorporated by reference herein in its entirety.

### FIELD OF INVENTION

The present disclosure relates to the field of electronic data collection. More particularly, the present disclosure relates to a gateway for facilitating data interoperability and portability.

### BACKGROUND

Data is collected in various industries for various purposes. Assessment data may be collected, for example, to determine a student's comprehension of particular subject matter studied in a classroom, to determine whether an individual is qualified to receive a particular credential, and so on. Administering an assessment in digital form enables more efficient collection, storage, and analysis of data. Digital data may also be easily shared with between various users and systems.

Assessment data may be collected from multiple distributed sources. The various distributed sources, however, may not all provide data in the same format. Collecting, storing, and analyzing data in multiple formats may be inefficient and time consuming. Additionally, sharing data may be inefficient and time consuming if the various users and systems require data in different formats.

### SUMMARY OF THE INVENTION

A dynamic data gateway comprises at least one processor, at least one computer-readable tangible storage device, and program instructions stored on the at least one storage device for execution by the at least one processor. The program instructions comprise first program instructions configured to receive data comprising a first format. The program instructions further comprise second program instructions configured to convert the received data to a second format. The program instructions further comprise third program instructions configured to store the converted data. The program instructions further comprise fourth program instructions configured to receive a request to provide the stored data in a requested format. The program instructions further comprise fifth program instructions configured to convert the stored data to the requested format.

In a method for sharing data, a computer receives data comprising a first format. A computer translates the data to a second format. A computer saves the translated data. A computer receives a request to provide the stored data in a requested format. A computer translates the stored data to the requested format. A computer communicates the requested data.

A computer program product for facilitating data exchange comprises at least one computer-readable tangible storage device and program instructions stored on the at least one storage device. The program instructions comprise first program instructions configured to aggregate data from a plurality of sources, the data comprising a plurality of secondary field names. The program instructions further comprise second program instructions configured to map the secondary field names of the receive data to predefined primary field names. The program instructions further comprise third program instructions configured to store the mapped data. The program instructions further comprise fourth program instructions configured to receive a request to provide the stored data in a requested format. The program instructions further comprise fifth program instructions configured to map the predefined primary field names, mapped to the stored data, to requested field names defined by the requested format.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example system for aggregating and sharing data.

FIG. 2 illustrates a block diagram of an example gateway for aggregating and sharing data.

FIG. 3 is a flow chart illustrating the steps of an example method for aggregating and sharing data.

FIG. 4 is a block diagram of an example computing system for implementing an example gateway for aggregating and sharing data.

### DETAILED DESCRIPTION

The following includes definitions of selected terms employed herein.

“API,” or an “application programming interface,” is a set of routines, protocols, and tools for building software applications.

An “assessment” or a “test” is any single question or group of questions.

“Computing device,” as used herein, refers to a laptop computer, a desktop computer, a smartphone, a personal digital assistant, a cellular telephone, a tablet computer, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Data Element” is an atomic unit of data that has precise meaning or precise semantics.

“Data Mapping” is a process of creating data element mappings between two distinct models.

“Education Data” are unique types of data that comes from learning environments, which include both student and adult learners.

“Interoperability” of data enables unconnected data portals to exchange data effectively and connect system components together seamlessly.

“Logic” includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmed logic device, memory device containing instructions, or the like. Logic may also be fully embodied as software.

“Portability” is the ability to reuse data across interoperable applications.

The definitions include various examples or forms of components that fall within the scope of a term and that may be used for implementation. The examples are not intended to be limiting. Both singular and plural forms of terms may be within the definitions.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

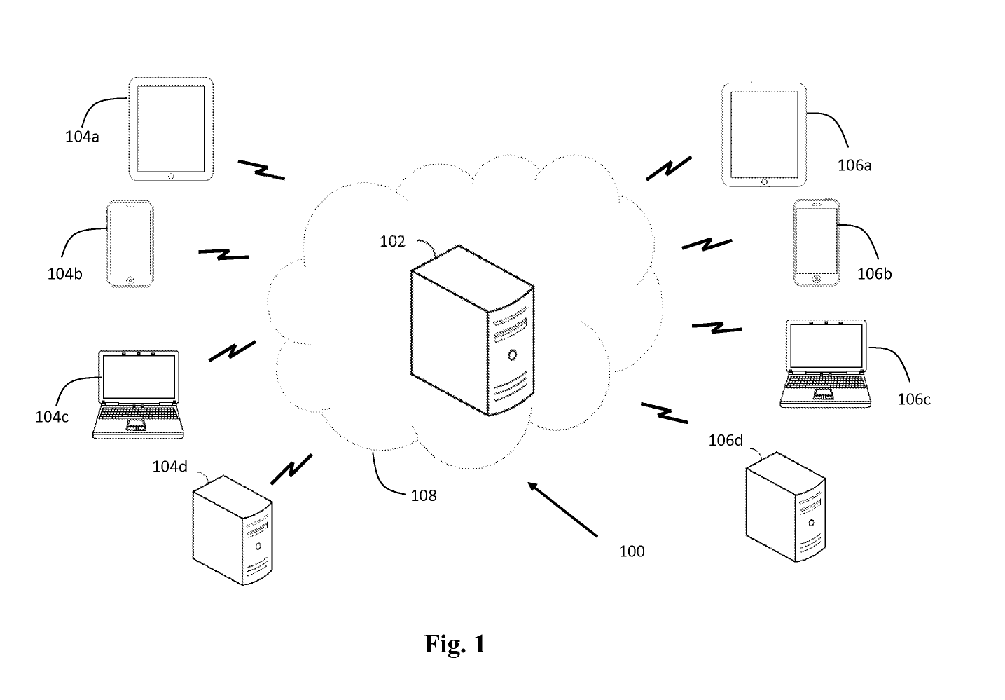

FIG. 1 is an example diagram of a system 100 for collecting and sharing data using a Dynamic Data Interoperability Gateway (hereinafter referred to as “the gateway”) 102. The gateway 102 enables and regulates data collection, storage, aggregation, standardization, and transmission. The gateway 102 is configured to be a bridge between data providers 104a, 104b, 104c, and 104d (hereinafter referred to as data provider 104) and data consumers 106a, 106b, 106c, and 106d (hereinafter referred to as data consumer 106) who desire to share or transfer similar sets of data but that produce and consume the data in different formats. Rather than enforce a data standard or format on all entities, the gateway 102 functions as a data translator that allows data to seamlessly flow between data providers 104 and data consumers 104, regardless of the individual entity's preference for data format. This allows the gateway 102 to deliver uniform data such that a variety of entities or systems may be engaged to share the data with little impact to individual entity's processes or systems.

A data provider 104 may be an individual, a non-profit, an organization, or a government, for example. Data provider 104 may communicate data to the gateway 102 via a tablet computer, a smartphone, a laptop computer, a desktop computer, or other similar computing device configured to communicate data.

A data consumer 106 may be an end user, hardware, a software application, a software developers kit, or anyone or anything capable of consuming data via a tablet computer, a smartphone, a laptop computer, a desktop computer, or other similar computing device configured to consume data.

The gateway 102 is configured to collect, store, and share student testing data. More particularly, the data can be divided into three different categories. First, the gateway 102 is configured to collect, store, and share information about students. For example, data includes student names, student identification numbers, demographic information, and other relevant information about students. The student data may also include identification information about testing devices used by the students to participate in a test. Testing devices used by students may include laptop computers, smartphones, or various types of audience response devices, for example. Second, the gateway 102 is configured to collect, store, and share test related content including questions, responses and answer keys. Third, the gateway 102 is configured to collect, store, and share data about how students perform on given tests. In other words, a combination of the first two types of data is collected and stored to indicate how specific students responded to specific questions.

It should be understood that, although the gateway 102 is described in the context of collecting, storing, and sharing student educational data, the gateway 102 may similarly be used in other applications for other types of data. For example, the gateway 102 may be used in the context of collecting, storing and sharing healthcare data, financial data, and so on.

The gateway 102 is implemented as a web-based solution. For example, the gateway 102 may be implemented as a cloud service that is accessible by a web browser or by another type of application or interface capable of communicating over the internet 108. In another example, the gateway 102 is configured to deliver services via web services using an appropriate interface. Protocols commonly used by web services are employed to exchange data amongst various software elements comprising the gateway 102.

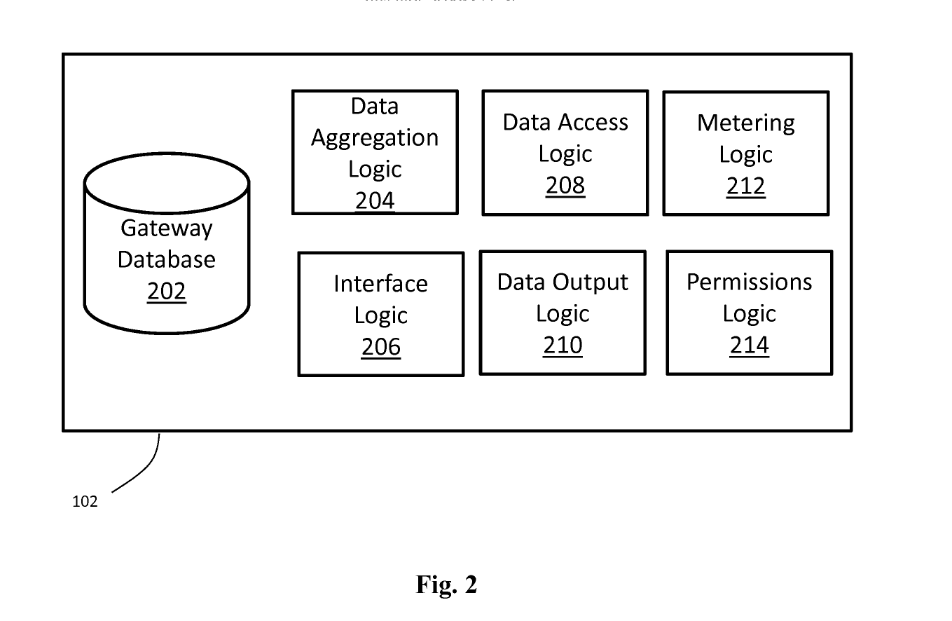

FIG. 2 illustrates a block diagram of an example gateway 102 for aggregating and sharing data. The gateway 102 is configured to function as a web-based repository for student educational data. The gateway 102 includes a gateway database 202 for storing student data. In one example, the Gateway may be defined to also include hardware configured to host the software and the database.

The gateway 102 further includes data aggregation logic 204 configured to provide the data aggregation functionality. In order to facilitate comprehensive data interoperability and in turn to promote data portability among multiple third party systems, data aggregation logic 204 encapsulates each participating third party system element and compensates for differences in naming conventions of each data element. Data aggregation logic 204 accomplishes this by mapping data elements in data sets received from third party systems to a standard format, or primary name, defined at the gateway 102. Data fields of various data sets often represent a single data element but may be named differently in those data sets, depending on the system or organization from which they originated. This is a significant barrier to data transfer between two independent systems. Data collected by the gateway 102 is automatically mapped by data aggregation logic 204 to universal, or primary, data field names. For example, a third party system may refer to a particular data element as “Student Number” while the gateway 102 may be configured to identify such a data element as “Student ID.” Accordingly, data aggregation logic 204 is configured to map the “Student Number” data field of a data set received from a third party system to the “Student ID” data element when storing the received data sets. This translation process provides a standardization of data elements that will enable data to be collected by the gateway 102 and to be seamlessly transferred to any other connecting portal of the gateway 102.

Within gateway database 202, a certain number of data element fields are predefined and designated with primary names. The gateway database 202 is also configured to store mapping rules which define how data aggregation logic 204 maps data elements from third party systems to these primary names. Like fields, or mapped fields received from third party systems, can be referred to as secondary names. Thus, there can only be one primary name for a data field but there can be unlimited number of secondary names for a data field.

It should be understood that although secondary data field names of received data sets are mapped to primary data field names, the secondary field names are still maintained by the gateway 102 in gateway database 202. Having records of secondary field names enables data aggregation logic 204 to automatically map an unidentified field name for which a mapping rule does not yet exist, by comparing the unidentified field name to the stored secondary field names.

Data aggregation logic 204 may perform mapping either automatically or manually. Specifically, data aggregation logic 204 may map a data element automatically when a mapping rule has been previously defined for that particular data element. Alternatively, data aggregation logic 204 may request a user or a systems administrator to create a new mapping rule. Data mapping rules may be defined by a gateway 102 systems administrator or by users and administrators of a third party system. Mapping rules may be predefined or may be added over time, or a combination of both. For example, a systems administrator may add a new mapping rule to the set of rules maintained in gateway database 202 upon discovering that a data element in a data set received from a third party system is not already associated with a mapping rule. Thus, the gateway mapping rules will grow dynamically over time as more third party systems contribute data to the gateway 102 and more data element definitions become available.

In one example, data aggregation logic 204 is configured to attempt to automatically map unknown or unidentified data elements as well. For example, data aggregation logic 204 may be configured to analyze an unknown data element or secondary data field name and to map the data element to a defined standard data element, or a primary data field name, by identifying similarities between the secondary field name and a primary field name or by identifying similarities between the secondary data field name and another secondary data field name for which a mapping rule already exists.

Thus, data aggregation logic 204 may be configured to recognize standard data formats such as Schools Interoperability Framework (SIF), Shareable Content Object Reference Model (Scorm), Learning Tools Interoperability (LTI), Basic Learning Tools Interoperability (BLTI), Extensible Markup Language (XML), Common Education Data Standards (CEDS), Application Integration Framework (AIF), and so on. However, data aggregation logic 204 is also configured to accommodate non-standard data formats.

Third party systems or entities connecting with the gateway 102 are expected to have common capabilities having common data elements. However, these capabilities may be presented in disparate fashion and there may be some feature differences from one party or system to another. For example, two different systems may both communicate a student identification number to the gateway 102. However, a first system may refer to the identification number as “Student ID” while a second system may refer to the same data as “ID Number.” Accordingly, data aggregation logic 204 is configured to interpret both data elements to convey the same information even though they are referred to differently by the providing system.

In one example, data aggregation logic 204 may be configured to identify missing data elements within a data set and to continue to process the data set. For example, data aggregation logic 204 may automatically assign a unique student identification number to a student upon determining that the data set is missing a data element indicative of a student identification number. Alternatively, data aggregation logic 204 may be configured to process the data set despite the missing data element. For example, data aggregation logic 204 may be configured to assign a null value, a “not applicable” value, or something similar to a particular data element in response to determining that a data set does not contain the particular data element.

In one example, gateway 102 encrypts student data before storing the data in gateway database 202. Gateway 102 may encrypt data using any method commonly known and used in the data storage and encryption industry. For example, the gateway 102 may secure data transfers by requiring use of public/private key cryptography. In one example, the gateway 102 may also require manual authentication by a user by prompting a user for access credentials. In one example, the gateway 102 also manages and archives the data after storing the data in gateway database 202. For example, the gateway 102 may be pre-set to receive or transfer data automatically based on an assigned schedule.

The gateway 102 further includes interface logic 206 for interfacing with data providers 104 and data consumers 106. Particularly, interface logic 206 receive and communicate data and to receive requests for stored data. Student data may be uploaded to the gateway 102 through a variety of means, including direct input, web services, manual upload, via radio frequency devices, and so on. In addition, student data may be uploaded from a variety of sources, including learning management systems such as Blackboard, virtual learning environments, or learning content management systems, for example. Data may be provided to these systems by individuals, organizations, non-profits, and government entities, for example. These sorts of entities communicate with the gateway 102 through interface logic 206.

It should be understood that a data provider 104 may also act as a data consumer 106. In other words, the same types of systems that provide data to the gateway 102 may also consume data from the gateway 102. For example, end users, as well as user applications such as TurningPoint and ResponseWare may consume data from the gateway 102, via interface logic 206.

In order to facilitate communication between the gateway 102 and third party systems and portals, the interface logic 206 includes Application Programming Interfaces, or APIs. The APIs of interface logic 206 enable third party systems and portals to transfer data to and receive data from the gateway 102 in a standardized manner without requiring those third party systems to have specific knowledge of the gateway's 102 functionality. Rather, the third party systems simply require knowledge of how to interact with the published APIs.

Interface logic 206 includes both proprietary and open APIs, published for third party use. Open APIs may not require encryption or may require less stringent encryption techniques while the proprietary APIs require third party systems to utilize more strict encryption techniques. The APIs do not allow for users to interact with data stored in gateway database 202 directly. Rather, the APIs only enable third party systems to interact with the data indirectly in order to ensure security and integrity of the data.

The interface logic 206 may include a variety of interface layers including interfaces for configuration of data connections, custom data mapping, scheduling or deploying data transfers, management of data to include editing or deleting, data management specific to proprietary software, reporting and/or analytics, billing and so on.

The gateway further includes data access logic 208 configured to enable user access to data stored in gateway database 202. Data access logic 208 does not allow a user or system to add new data to gateway database 202. In one example, data access logic 208 only enables a user to view current data. In one example, data access logic 208 may enable a user to edit currently stored data as well as to view the data. Data access logic 208 provides a variety of components which in turn provide access to various stored data. For example, an organizational component provides access to information about organizations that the gateway 102 is configured to interface with. A content component provides access to the test content such as questions and answer keys. Other similar types of components such as payment component, inventory component, assessment data component, direct marketing component, and registration component all provide access to view and edit respective stored data as well. In one example, the data access logic 208 may provide a single component or application for viewing and editing all stored data.

The gateway 102 further includes data output logic 210 for converting stored data to a requested format. By mapping, standardizing, and encrypting received data, the gateway 102 is able to securely and efficiently port data to third party systems or portals. In other words, the data stored in gateway database 202 is designed for portability. Specifically, data output logic 210 is able to accommodate requests for data submitted by third party systems by mapping the requested data from the standardized form, or the primary field names, to the secondary field names as defined by the third party system. Data output logic 210 determines a format required by the third party system and maps the stored data accordingly. Data output logic 210 can perform the mapping automatically if a mapping rule has already been defined for the data format required by the third party system requesting the data or if a mapping rule can be determined by comparing the secondary field names of the format required by the requesting third party to already known secondary field names. Otherwise, data output logic 210 may perform the mapping according to manual input by a systems administrator.

In one example, the gateway 102 included data metering logic 212 configured to meter data consumption by third party systems. Data metering logic 212 monitors how much data is being consumed or received by a third party system. This enables an administrator of the gateway 102 to track the amount of data being consumed, to charge a fee for consuming data, to set limits on the amount of data being consumed, and so on. Data metering logic 212 may monitor data usage based on individual data records consumed, or based on the size and amount of data being consumed.

It should be understood that providers of data may or may not also be consumers of data. Accordingly, data metering logic 212 may initiate data monitoring either when the gateway 102 ports data back to the original provider of the data or when the gateway 102 ports data to third party systems consuming data.

The gateway 102 also includes a roles and permissions logic 214 configured to grants certain permissions to users or third party systems based on authentication of credentials provided by the user or third party system. For example, permissions logic 214 may grant student access to a response device being used by a student to answer questions on a test. Student access level granted by permissions logic 214 may limit the response device to only transmit data to the gateway 102 but not to view or edit the data. A computer being used by an instructor or a proctor to administer a test, however, may be granted instructor access level by permissions logic 214 which may allow the instructor to view response submitted by his students, for example. Other access roles may include an Admin level, a Super Admin level, or other suitable roles deemed appropriate.

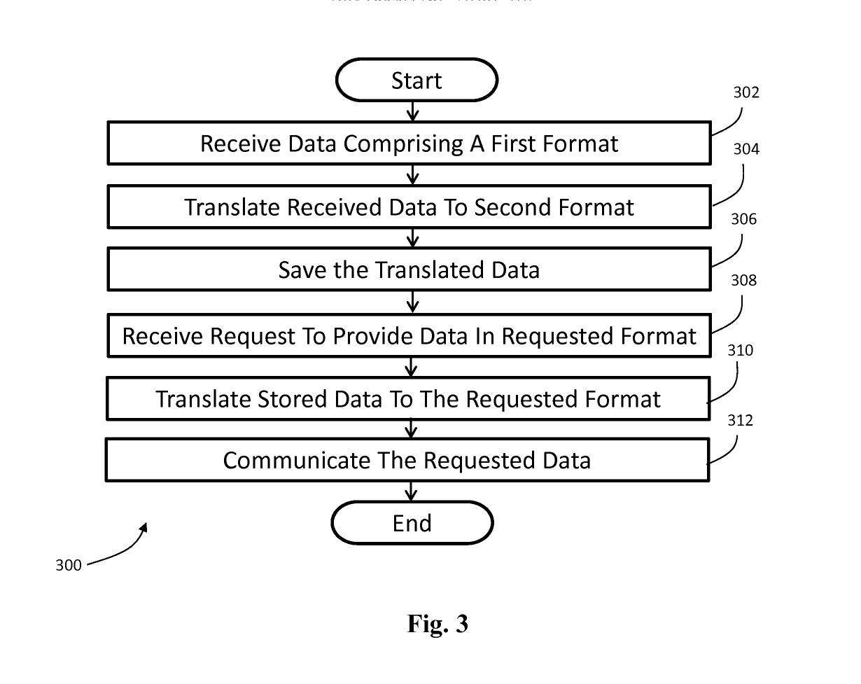

FIG. 3 is a flow chart illustrating the steps for collecting and sharing data using a dynamic data interoperability gateway. At step 302, the gateway 102 receives data comprising a first format. At step 304, the gateway 102 translates the data into a second standard format. At step 306, the gateway 102 saves the translated data. At step 308, the gateway 102 receives a request to provide the stored data in a requested format. At step 310, the gateway 102 determines the format requested and translates the stored data to the requested format. At step 312, the gateway communicates or ports the translated data to the requesting user or system. In one example, the gateway 102 also meters the amount of data being consumed or requested.

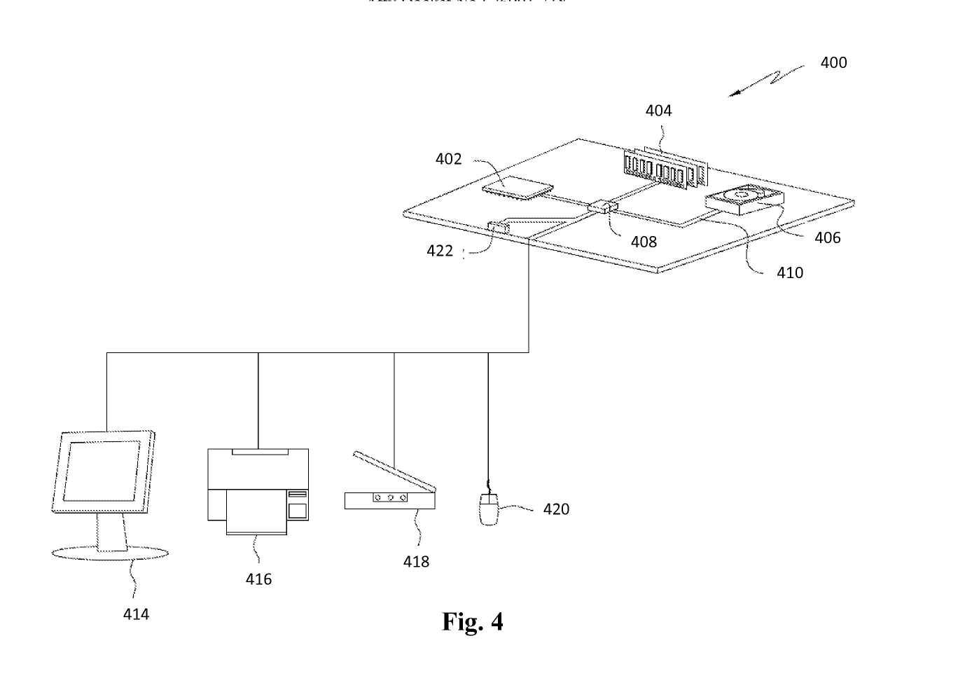

FIG. 4 is a block diagram of an example computing system 400 for implementing an example gateway for aggregating and sharing data. The example computing system 400 is intended to represent various forms of digital computers, including laptops, desktops, handheld computers, smartphones, tablet computers, servers, and other similar types of computing devices. As shown, computing system 400 includes a processor 402, memory 404, a storage device 406, and a communication port 422, operably connected by an interface 408 via a bus 410.

Processor 402 processes instructions, via memory 404, for execution within computing system 400. In an example embodiment, multiple processors along with multiple memories may be used.

Memory 404 may be volatile memory or non-volatile memory. Memory 404 may be a computer-readable medium, such as a magnetic disk or optical disk. Storage device 406 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 404 or storage device 406.

Computing system 400 may be coupled to one or more input and output devices such as a display 414, a printer 416, a scanner 418, and a mouse 420.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A dynamic data gateway comprising:
at least one processor, at least one computer-readable tangible storage device, and program instructions stored on the at least one storage device for execution by the at least one processor, the program instructions comprising:
first program instructions configured to receive data comprising a first format;
second program instructions configured to convert the received data to a second format;
third program instructions configured to store the converted data;
fourth program instructions configured to receive a request to provide the stored data in a requested format; and
fifth program instructions configured to convert the stored data to the requested format.

2. The data gateway of claim 1, wherein the program instructions further comprise sixth program instructions configured to receive an access credential and to grant access to the stored data based on the access credential.

3. The data gateway of claim 1, wherein the second program instructions are configured to convert the received data to a second format by mapping at least one data element, comprising a secondary field name, of the received data to a primary field name.

4. The data gateway of claim 3, wherein the fifth program instructions are configured to convert the stored data to a requested format by mapping at least one data element, comprising a primary field name, of the stored data to a defined field name associated with the requested format.

5. The data gateway of claim 3, wherein the second program instructions are configured to map the at least one data element based on a predefined mapping rule associated with the secondary field name.

6. The data gateway of claim 3, wherein the second program instructions are configured to map the at least one data element based on an identified predefined mapping rule associated with a field name that most closely matches the secondary field name.

7. The data gateway of claim 1, wherein the data comprises student assessment data.

8. The data gateway of claim 1, wherein the second program instructions are further configured to identify the received data to be missing a data element and to automatically add additional data, corresponding to the missing data element, to the received data.

9. The data gateway of claim 1, further comprising sixth program instructions configured to encrypt the converted data.

10. The data gateway of claim 1, further comprising sixth program instructions configured to monitor the number of requests received for providing the data.

11. A method for sharing data, comprising the steps of:
a computer receiving data comprising a first format;
a computer translating the data to a second format;
a computer saving the translated data;
a computer receiving a request to provide the stored data in a requested format;
a computer translating the stored data to the requested format; and
a computer communicating the requested data.

12. The method of claim 11, further comprising the steps of:
a computer receiving an access credential; and
a computer granting access to the stored data based on the access credential.

13. The method of claim 11, wherein the step of the computer translating the data to a second format comprises the computer mapping at least one data element, comprising a secondary field name, of the received data to a primary field name.

14. The method of claim 13, wherein the step of the computer translating the stored data to the requested format comprises the computer mapping at least one data element, comprising a primary field name, of the stored data to a defined field name associated with the requested format.

15. The method of claim 13, wherein the step of the computer mapping the at least one data element comprises the computer mapping the at least one data element based on a predefined mapping rule associated with the secondary field name.

16. The method of claim 13, wherein the step of the computer mapping the at least one data element comprises:
the computer identifying a stored field name that most closely matches the secondary field name; and
the computer mapping the at least one data element based on a predefined mapping rule associated with the identified stored file.

17. The method of claim 11, further comprising the steps of:
a computer identifying the received data to be missing a data element; and
a computer automatically adding additional data, corresponding to the missing data element, to the received data.

18. The method of claim 11, further comprising the step of the computer encrypting the converted data.

19. A computer program product for facilitating data exchange, the computer program product comprising:
at least one computer-readable tangible storage device and program instructions stored on the at least one storage device, the program instructions comprising:
first program instructions configured to aggregate data from a plurality of sources, the data comprising a plurality of secondary field names
second program instructions configured to map the secondary field names of the receive data to predefined primary field names;
third program instructions configured to store the mapped data;
fourth program instructions configured to receive a request to provide the stored data in a requested format; and
fifth program instructions configured to map the predefined primary field names, mapped to the stored data, to requested field names defined by the requested format.

20. The computer program product of claim 19, wherein the second program instructions are configured to:
map the secondary field names associated with known data elements of the receive data to predefined primary field names based on predefined mapping rules associated with the known data elements; and
map the secondary field names associated with unknown data elements of received data to predefined primary data field names by comparing the unknown data elements to known data elements and selecting mapping rules associated with known data elements that most closely match the unknown data elements.
